(19) United States
(12) Patent Application Publication
(10) Pub. No.: US 2016/0169190 A1
(43) Pub. Date: Jun. 16, 2016

(54) ROTOR BLADE SURFACE FEATURE INSTALLATION SYSTEMS AND METHODS

(71) Applicant: General Electric Company, Schenectady, NY (US)

(72) Inventors: Ulrich Werner Neumann, Simpsonville, SC (US); Scott Gabell Riddell, Greer, SC (US)

(73) Assignee: General Electric Company

(21) Appl. No.: 14/568,415

(22) Filed: Dec. 12, 2014

(51) Int. Cl. F03D 1/00; F03D 1/06

(52) U.S. Cl. CPC F03D 1/001; F03D 1/06

(57) ABSTRACT

A method for installing a surface feature on a wind turbine rotor blade includes disposing the surface feature on a surface of the rotor blade with an adhesive material disposed there between, disposing a seal between at least a portion of the surface feature and the rotor blade to form a chamber there between, and, pulling a vacuum from the chamber to produce a substantially uniform force pulling the surface feature against the surface of the rotor blade.

### BACKGROUND OF THE INVENTION

The subject matter disclosed herein relates to wind turbine rotor blades and, more specifically, to systems and methods for installing surface features on wind turbine rotor blades.

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The particular size of wind turbine rotor blades is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, as rotor blade sizes increase, so do the loads transferred through the blades to other components of the wind turbine (e.g., the wind turbine hub and other components). For example, longer rotor blades result in higher loads due to the increased mass of the blades as well as the increased aerodynamic loads acting along the span of the blade. Such increased loads can be particularly problematic in high-speed wind conditions, as the loads transferred through the rotor blades may exceed the load-bearing capabilities of other wind turbine components.

Certain surface features, such as spoilers may be utilized to separate the flow of air from the outer surface of a rotor blade, thereby reducing the lift generated by the blade and reducing the loads acting on the blade. Other surface features, such as vortex generators, may delay separation of the air flowing over a rotor blade to increase loads during periods of decreased wind. However, these and other surface features are often secured to the existing rotor blade using various forms of adhesive material (e.g., tape, glue or the like). Applying pressure on the surface feature against the rotor blade while the adhesive material sets may be a manual operation subject to some level of variance.

Accordingly, alternative systems and methods for installing surface features on wind turbine rotor blades would be welcome in the art.

### BRIEF DESCRIPTION OF THE INVENTION

In one embodiment, a method for installing a surface feature on a wind turbine rotor blade. The method includes disposing the surface feature on a surface of the rotor blade with an adhesive material disposed there between, disposing a seal between at least a portion of the surface feature and the rotor blade to form a chamber there between, and, pulling a vacuum from the chamber to produce a substantially uniform force pulling the surface feature against the surface of the rotor blade.

In another embodiment, a rotor blade surface feature installation system is disclosed. The rotor blade surface feature installation system includes a seal disposed between a surface feature and a surface of a rotor blade to form a chamber there between, wherein an adhesive material is disposed between the surface feature and the surface, and, a pump configured to pull a vacuum from the chamber to produce a substantially uniform force pulling the surface feature against the surface of the rotor blade.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a perspective view of a wind turbine having one or more rotor blades according to one or more embodiments shown or described herein;

FIG. 2 is a perspective view of a rotor blade of the wind turbine illustrated in FIG. 1 according to one or more embodiments shown or described herein;

FIG. 3 is a method for installing a surface feature on a wind turbine rotor blade according to one or more embodiments shown or described herein;

FIG. 4 is a cross-sectional view of a rotor blade surface feature sealing system according to one or more embodiments shown or described herein; and,

FIG. 5 is a top view of a rotor blade surface feature sealing system according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

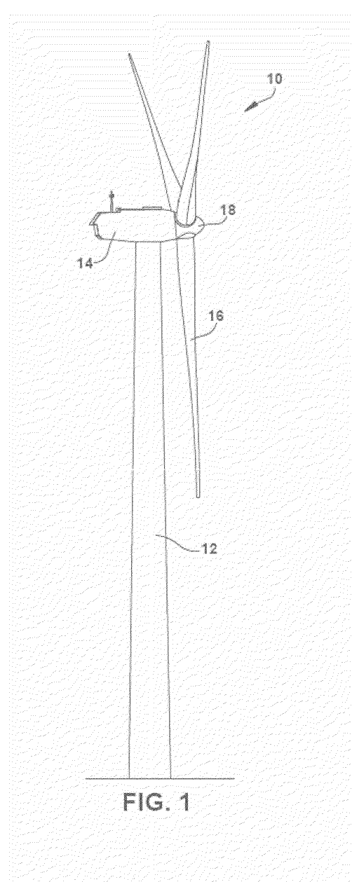

Referring now to FIG. 1 a wind turbine 10 of conventional construction is illustrated. The wind turbine 10 includes a tower 12 with a nacelle 14 mounted thereon. A plurality of rotor blades 16 are mounted to a rotor hub 18, which is in turn connected to a main flange that turns a main rotor shaft. Depending on the configuration of the wind turbine 10, the plurality of rotor blades 16 can, for example, be mounted to the rotor hub 18 indirectly through a pitch bearing (not illustrated) or any other operable connection technique. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration

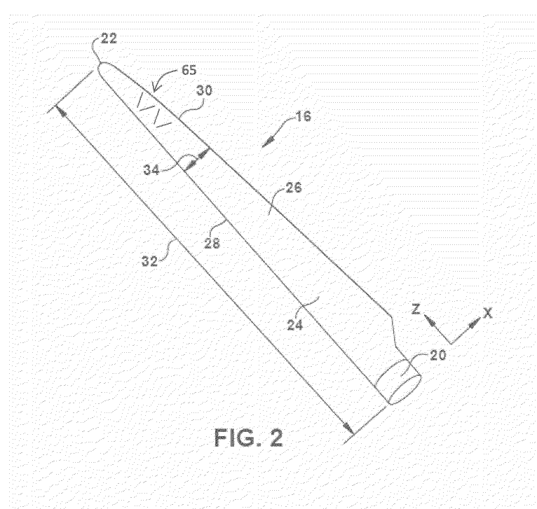

Referring now to FIG. 2, a perspective view of a rotor blade 16 is illustrated. The rotor blade 16 can include a root end 20 for mounting the rotor blade 16 to a mounting flange (not illustrated) of the wind turbine hub 18 (illustrated in FIG. 1) and a tip end 22 disposed opposite to the root end 20. The rotor blade 16 may comprise a pressure side 24 and a suction side 26 extending between a leading edge 28 and a trailing edge 30. In addition, the rotor blade 16 may include a span 32 defining the total length between the root end 20 and the tip end 22. The rotor blade 16 can further comprise a chord 34 defining the total length between the leading edge 28 and the trailing edge 30. It should be appreciated that the chord 34 may vary in length with respect to the span 32 as the rotor blade 16 extends from the root end 20 to the tip end 22.

The rotor blade 16 may define any suitable aerodynamic profile. Thus, in some embodiments, the rotor blade 16 may define an airfoil shaped cross-section. For example, the rotor blade 16 may also be aeroelastically tailored. Aeroelastic tailoring of the rotor blade 16 may entail bending the blade 16 in generally a chordwise direction x and/or in a generally spanwise direction z. As illustrated, the chordwise direction x generally corresponds to a direction parallel to the chord 34 defined between the leading edge 28 and the trailing edge 30 of the rotor blade 16. Additionally, the spanwise direction z generally corresponds to a direction parallel to the span 32 of the rotor blade 16. In some embodiments, aeroelastic tailoring of the rotor blade 16 may additionally or alternatively comprise twisting the rotor blade 16, such as by twisting the rotor blade 16 in generally the chordwise direction x and/or the spanwise direction z.

The rotor blade 16 may comprise one or more surface features 60 such as vortex generators 65 (as illustrated), rotor blade extensions, serration panels, patches, or any other surface feature that may be added to the exterior surface 51 of the rotor blade 16.

For example, in some embodiments, the surface feature 60 may comprise one or more vortex generators 65 as illustrated in FIGS. 2-5. Vortex generators 65 can refer to any protrusion, extension, or other feature that partially disrupts or otherwise alters airflow passing over one or more portions of the rotor blade 16. For example, vortex generators may comprise spoiler positions, vortex generator positions, or be able to transition there between.

As used herein, the spoiler position can refer to a position that separates air flowing over the rotor blade 16 from the surface 51 of the shell 50, thereby reducing the lift generated by the rotor blade 16 and decreasing the loads transferred through the rotor blade 16 to other components of the wind turbine 10 (e.g., the rotor hub 18 of the wind turbine 10 illustrated in FIG. 1). For example, one or more vortex generators 65 may be substantially parallel with the span 32 of the rotor blade 16 when in the spoiler position. The spoiler position may thereby be utilized during increased loading on the rotor blade 16 (e.g., during operation in high-speed wind conditions). As also used herein, the vortex generator position can refer to a position that delays flow separation of air flowing over the rotor blade 16 from the surface 51 of the shell 50. In the vortex generator position, the vortex generators may comprise a plurality of vanes, bumps, ridges and/or other configurations to create a vortex in the air flowing along the surface 51 of the shell 50. Vortices created by the plurality of vortex generators 65 in the vortex generator position can increase the forward momentum of the airflow, thereby encouraging the air to remain attached to the surface 51. The vortex generator position may thereby be utilized to increase loading on the rotor blade 16.

In some embodiments, the surface feature 60 may comprise a rotor blade extension. The rotor blade extension can comprise any feature that extends one or more dimensions of the rotor blade 16. For example, in some embodiments, the rotor blade extension may be disposed at the tip end 22 of the rotor blade 16. In such embodiments, the rotor blade extension can thereby extend the overall length of the span 32 so as to make a longer rotor blade 16. In some embodiments, the rotor blade extension may be disposed at the leading edge 28, trailing edge 30, pressure side 24 or suction side 26 of the rotor blade 16. For example, in some embodiments, the surface feature 60 may comprise a serration panel that has a serrated (e.g., jagged) edge. The serration panel can, for example, be disposed at the trailing edge 30 of the rotor blade 16 to help alter the turbulence of air flow leaving the rotor blade 16.

In some embodiments, the surface feature 60 may comprise a patch. The patch may be utilized to modify (e.g., repair) the surface 51 of the shell 50 such as when the shell 50 comprises a hole, indentation, or any location for repair, such as when may occur from hail, object collision, or the like. The patch may smooth out the surface 51, cover a hole, or otherwise modify the existing surface 51 of the rotor blade 16.

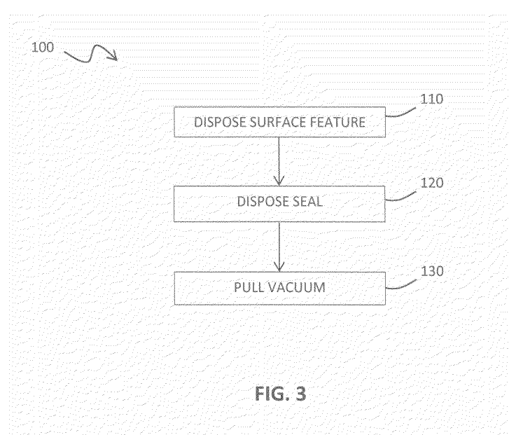

Referring now additionally to FIGS. 3-5, a method 100 is illustrated for installing a surface feature 60 on a wind turbine 10 rotor blade 16, such as by using a rotor blade surface feature sealing system 55. The method 100 and system 55 may be utilized on new make rotor blades 16 or to modify existing rotor blades 16, either at an original factory, repair facility, at an installation site, or even up-tower with the rotor blade 16 still connected to the rotor hub 18.

The method 100 can first generally comprise disposing the surface feature 60 onto the surface 51 of the rotor blade 16 with an adhesive material 62 disposed there between (i.e., between the surface feature 60 and the surface 51 of the rotor blade 16) in step 110. The surface feature 60 may comprise one or more of a variety of surface features such as including, but not limited to, the vortex generators 65 (as illustrated), rotor blade extensions, serration panels, patches discussed above. Moreover, the surface feature 60 may be disposed at one or more of a variety of locations on the surface 51 of the rotor blade 16 such as including, but not limited to, the root end 20, the tip end 22, the pressure side 24, the suction side 26, the leading edge 28, or the trailing edge 30.

The adhesive material 62 can be disposed between the surface feature 60 and the surface 51 in any suitable manner. For example, the adhesive material 62 may be applied to the underside of the surface feature 60 prior to disposing the surface feature 60 is disposed on the shell 50. In other embodiments, the adhesive material 62 may be disposed on the surface 51 prior to disposing the surface feature 60 thereon.

The adhesive material 62 can comprise any suitable material for bonding the surface feature 60 to the surface 51 of the rotor blade 16. For example, the adhesive material can comprise any suitable glue, tape, epoxy, caulk or the like, or combinations thereof. In some embodiments, the adhesive material may comprise double sided tape such as commercially available VHB tape. The adhesive material 62 may further comprise a curing time during which the adhesive material 62 cures (e.g., sets, hardens, solidifies or the like). The adhesive material 62 may cure with or without the assistance of heating, air or the like and may cure over any suitable period of time.

The method 100 can further generally comprise disposing a seal 70 between at least a portion of the surface feature 60 and the rotor blade 16 (e.g., the surface 511 of the shell 50) to form a chamber 75 there between in step 120.

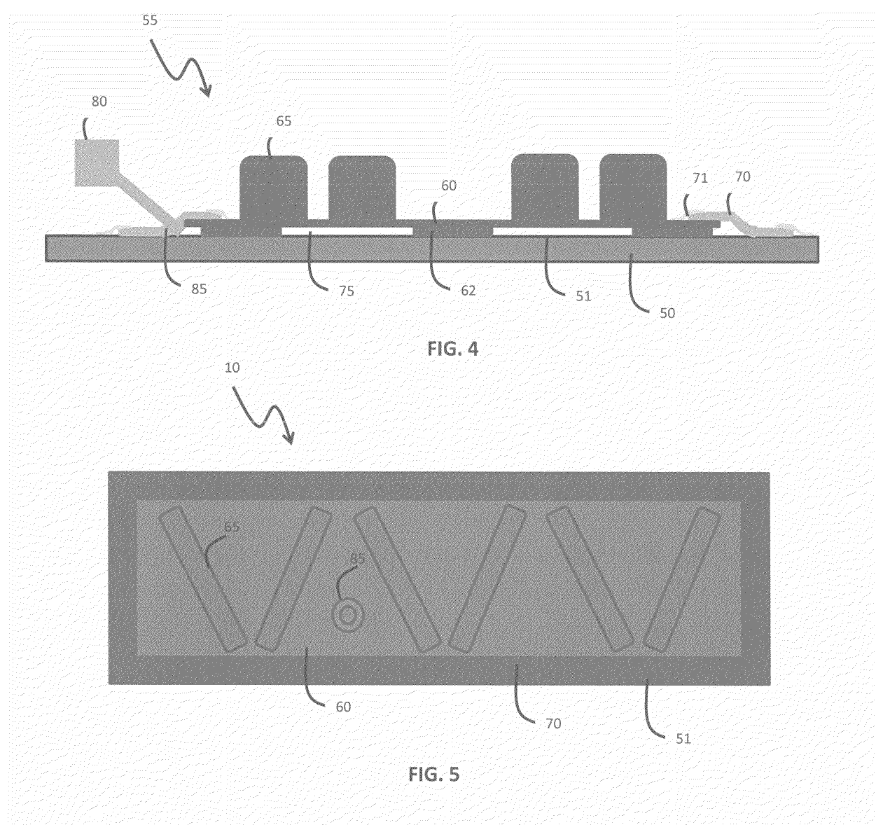

As best illustrated in FIGS. 4 and 5, the seal 70 can comprise any configuration and material that forms the chamber 75 comprising any enclosed volume that can have a vacuum pulled therefrom so as to force the surface feature 60 against the surface 51 of the rotor blade 16. For example, in some embodiments, the seal 70 can comprise a component wrapped around and between the surface feature 60 and the surface 51 of the rotor blade 16. The seal 70 in such embodiments can comprise a single material or a combination of materials. For example, the seal 70 may comprise an elastomeric material, a caulk material or any other suitable material or materials that can limit or avoid leaks when pulling the vacuum from the chamber 75.

In some particular embodiments, such as when the seal 70 comprises an elastomeric material (e.g., 70), the seal 70 may further comprise a bit of adhesive material to help keep the seal 70 in place while the vacuum is pulled from the chamber 75. In some embodiments, the seal 70 may be heated, such as by a heater, before, during or after the seal 70 is disposed between the surface feature 60 and the surface 51 of the rotor blade 16. Such embodiments may help ensure the seal 70 does not leak even in colder conditions, such as may occur when utilizing the method 100 or rotor blade surface feature sealing system 55 for up tower operations. In some embodiments, the seal 70 may be held in place by one or more additional brackets 71 against the surface feature 60 and/or the surface 51 of the rotor blade 16.

Moreover, the seal 70 can be utilized between any or just a portion of the surface feature 60 and the shell 51 of the rotor blade 16. For example, the seal 60 may be wrapped around the entire circumference of the surface feature 60 (as illustrated in FIGS. 4 and 5), or for just a portion of the surface feature 60. In some embodiments, a single seal 70 multiple seals 70 may be used to form a single chamber 75 or multiple chambers 75 for a single surface feature 60. In some embodiments, a single seal 70 or a plurality of seals 70 may be used to form a single chamber 75 or a plurality of chambers 75 for a plurality of surface features 60. While specific embodiments of seals 70 have been disclosed and presented herein, it should be appreciated that these embodiments are non-limiting and exemplary only; any other suitable configuration may additionally or alternatively be realized.

The method 100 can further generally comprise pulling a vacuum from the chamber 75 to produce a substantially uniform force pulling the surface feature 60 against the surface 51 of the rotor blade 16. The vacuum can be pulled using any suitable pump or other device to create an external pressure outside of the chamber 75 that is greater than the internal pressure inside the chamber 75. By pulling the vacuum 75 to create this pressure differential, the surface feature 60 can be forced against the surface 51 of the rotor blade 16 with a more uniform pressure. This, in turn, can allow for the adhesive material 62 to cure while a more uniform force keeps the surface feature 60 against the surface 51 of the rotor blade 16.

For example, in some embodiments, such as that illustrated in FIG. 4, the seal 70 may comprise one or more ports 85 for connecting a pump 80 thereto for pulling the vacuum. In some embodiments, such as that illustrated in FIG. 5, the surface feature 60 may comprise one or more ports 85 for connecting a pump 80 thereto for pulling the vacuum. In such embodiments, the method 100 may further comprise sealing the one or more ports 85 after the vacuum is pulled and/or the adhesive material 62 is cured. The port 80 can be sealed using any suitable material such as the same material the makes up the shell 50 of the rotor blade 16.

As best illustrated in FIGS. 4 and 5, in some embodiments, the method 100 may be practiced using a rotor blade surface feature installation system 55. The rotor blade surface feature installation system 55 can comprise a seal 70 disposed between the surface feature 60 and the surface 51 of the rotor blade 16 to form the chamber 75 there between, wherein the adhesive material 62 is disposed between the surface feature 60 and the surface 51. The rotor blade surface feature installation system 55 can further comprise a pump 80 configured to pull the vacuum from the chamber 75 to produce a substantially uniform force pulling the surface feature 60 against the surface 51 of the rotor blade 16. In some embodiments, such as when the seal 70 comprises an elastomeric material, the rotor blade surface feature installation system 55 may further comprise a heater to heat the seal 70 before, during and/or after pulling the vacuum or while the adhesive material 62 cures.

It should now be appreciated that rotor blade surface feature sealing systems and methods may be utilized to apply a more uniform force keeping a surface feature against the surface of the rotor blade while an adhesive material cures. The disclosed methods and systems may be used on new or existing parts and may be performed in a variety of locations, including during up-tower repairs.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for installing a surface feature on a wind turbine rotor blade, the method comprising:
disposing the surface feature on a surface of the rotor blade with an adhesive material disposed there between;
disposing a seal between at least a portion of the surface feature and the rotor blade to form a chamber there between; and,
pulling a vacuum from the chamber to produce a substantially uniform force pulling the surface feature against the surface of the rotor blade.

2. The method of claim 1, wherein the surface feature comprises a panel comprising one or more vortex generators.

3. The method of claim 1, wherein the surface feature comprises a rotor blade extension.

4. The method of claim 3, wherein the rotor blade extension is disposed at a tip end of the rotor blade.

5. The method of claim 1, wherein the surface feature comprises a serration panel.

6. The method of claim 5, wherein the serration panel is disposed at a trailing edge of the rotor blade.

7. The method of claim 1, wherein pulling the vacuum occurs while the adhesive material cures.

8. The method of claim 1, wherein the seal comprises an elastomeric material.

9. The method of claim 8, further comprising heating the elastomeric material.

10. The method of claim 1, wherein the surface feature comprises a port, and wherein the vacuum is pulled through the port.

11. The method of claim 10, further comprising sealing the port after pulling the vacuum.

12. A rotor blade surface feature installation system comprising:
a seal disposed between a surface feature and a surface of a rotor blade to form a chamber there between, wherein an adhesive material is disposed between the surface feature and the surface; and,
a pump configured to pull a vacuum from the chamber to produce a substantially uniform force pulling the surface feature against the surface of the rotor blade.

13. The rotor blade surface feature installation system of claim 12, wherein the surface feature comprises a panel comprising one or more vortex generators.

14. The rotor blade surface feature installation system of claim 12, wherein the surface feature comprises a rotor blade extension.

15. The rotor blade surface feature installation system of claim 12, wherein the surface feature comprises a serration panel.

16. The rotor blade surface feature installation system of claim 12, wherein the pump is configured to pull the vacuum while the adhesive material cures.

17. The rotor blade surface feature installation system of claim 12, wherein the seal comprises an elastomeric material.

18. The rotor blade surface feature installation system of claim 17, further comprising configured to heat the elastomeric material.

19. The rotor blade surface feature installation system of claim 12, wherein the pump is configured to pull the vacuum through a port in the surface feature.

20. The rotor blade surface feature installation system of claim 12, wherein the pump is configured to pull the vacuum through a port in the seal.
